(19) United States
(12) Patent Application Publication
(10) Pub. No.: US 2013/0297394 A1
(43) Pub. Date: Nov. 7, 2013

(54) Electronic Shopper Loyalty Card & Interactive Web Interface

(71) Applicants: Scott Holmes Stapleford, Londonderry, NH (US); Gary Nelson Stapleford, Londonderry, NH (US)

(72) Inventors: Scott Holmes Stapleford, Londonderry, NH (US); Gary Nelson Stapleford, Londonderry, NH (US)

(21) Appl. No.: 13/460,947

(22) Filed: May 1, 2012

(51) Int. Cl. G06K 19/067; G06K 5/00; G06Q 30/02

(52) U.S. Cl. 705/14.27; 235/492; 235/382

(57) ABSTRACT

A system for adding a reliable, non-obtrusive or distracting method to gather and process consumer behavior and interest when a sale is not made in the retail environment. The system would allow for the display of this information back to the consumer though a web landing page and would allow retailers and product manufacturers to make offers to the consumer based upon certain criteria that could include frequency to the store, aisles traveled or stops during the aisle travel to look at but not necessary purchase the product. Additionally the system would give the ability to the consumer to unlock secured display cabinets to access product since they would be considered a “trusted” source.

### FIELD OF THE INVENTION

Embodiments of this invention generally relate to a consumer using an electronic wireless shopper loyalty card that transmits and receives data when used in a retail environment. The action of making any purchase of a product or service is not required to collect data on the consumer's actions while in the retail store. The amount of data that is collected and processed is fully controlled and configured by the consumer using a specially designed and secured web page. The retailer or product manufacturer would have access to this data collected as well to assign loyalty points, printable coupons, promotional items and free product samples to the consumer.

Additional embodiments would include the use of the electronic shopper loyalty card to facilitate the automatic unlocking of locked display cabinets in the retail environment in the presence of the card.

### BACKGROUND

Currently most retail establishments have a static loyalty card that is presented during checkout in which the barcode on the card is scanned. This data is gathered into a centralized database and analyzed by the retailers and product manufacturers and then used to drive new sales from a known consumer buying pattern. The method for driving these new sales may be in the form of coupons or sales promotions that are either mailed or printed out from the retailer's website.

Retailers also have enabled smartphone users to scan “Q” or “QR Codes” while in the store to get more product information or to bring them to the retailer's web page. This method generally does not allow the retailer to make a connection back to the consumer and additionally disrupts the consumers buying experience with another distraction. Additionally, just the act of getting consumers to use their smartphone while shopping promotes barcode scanning and competitive price shopping which creates lost sales opportunities.

Moreover, retailers continually inconvenience loyal customers by high theft item products being either locked up in cabinets or security hooks. The act of having product secured and not in an “open” consumer friendly environment causes increased lost sales because of a number of factors which include but are not limited to; customer not wanting to ask for help; customer being in a rush or not wanting to wait; or they may not want to interact with a customer service button.

What is needed in the art is a reliable, non-obtrusive or distracting way to gather and process consumer behavior and interests when a sale is not made. This data would be used by the retailers and product manufacturers to make better decisions from how and where they advertise to store layout and planning. The consumer would benefit by getting loyalty points for browsing through the store and improve their shopping experience with the additional ability to unlock secured display cabinets since they would be considered a “trusted” source.

### SUMMARY

Systems according to some embodiments of this invention provide a web landing page where the consumer would register with a minimum of a user name, password and electronic shopper loyalty card identification number. Additional non-required user information on the web landing page can be entered about the consumer which would generate more loyalty points or a multiplier value on the points as they are accumulated. The more information that is entered would be valuable to the retailers or product manufacturers since they could use this data to better understand that consumer's needs.

In some embodiments, the electronic shopper loyalty card would be attached to the consumer's key ring similar to that of a key or a charm. The electronic shopper loyalty card could be turned on and off by the consumer depending upon what privacy levels they require at that time.

In some embodiments, the consumer would enter the retail environment with the electronic shopper loyalty card and be identified by the store's electronic shopper loyalty card transceivers that are setup throughout the retail environment. Depending upon the level of data required by the store, the transceivers would gather the following information; how long was the consumer in the store, which aisles were traveled and did the consumer stop and look at a category of products. The amount of information is not limited to the above list but is an example of what data could be gathered.

In some embodiments, the electronic shopper loyalty card transceivers throughout the store would upload the data collected from the electronic shopper loyalty cards via the Internet. This data when uploaded would be stored in a centralized database where it would be processed by the retailer or product manufacturer. This processing would allow awarding of loyalty points, promotional items and product samples to the consumer via the web interface.

In some embodiments, when the consumer plugs the electronic shopper loyalty card into their computer's USB port it would automatically launch to the electronic shopper loyalty card's Internet website landing page. Once launched, the consumer would enter their user name and password that was previously completed in the account setup. The consumer then will be able to view loyalty points awarded, printable coupons, promotional items and free product manufactures samples based upon their shopping or instore browsing habits. The amount of information is not limited to the above list but is an example of what information could be displayed or offered to the consumer.

In some embodiments, the electronic shopper loyalty card would also allow the consumer to activate a solenoid lock on secured display cabinets to allow access to product. This activation would be initiated by pressing the unlock button on the electronic shopper loyalty card in which the store display cabinets would receive a wireless unlock code via a built in receiver. If the receiver is coded to allow this “trusted” source then it would active a mechanical solenoid that would release the cabinet lock to access the product. Once the door was closed the cabinet would relock itself thus protecting the secured product.

### BRIEF DESCRIPTION OF THE DRAWINGS

FIG. 1 is a perspective view of the electronic shopper loyalty card.

FIG. 2 is a perspective view of the instore transceivers.

FIG. 3 is a perspective view of the display locking mechanism.

FIG. 4 is a screen view of the electronic shopper loyalty card web application.

FIG. 5 is a process flow illustrating one non-limiting example of the logic that could be carried out by the system to collect and process data according to one embodiment of the present invention.

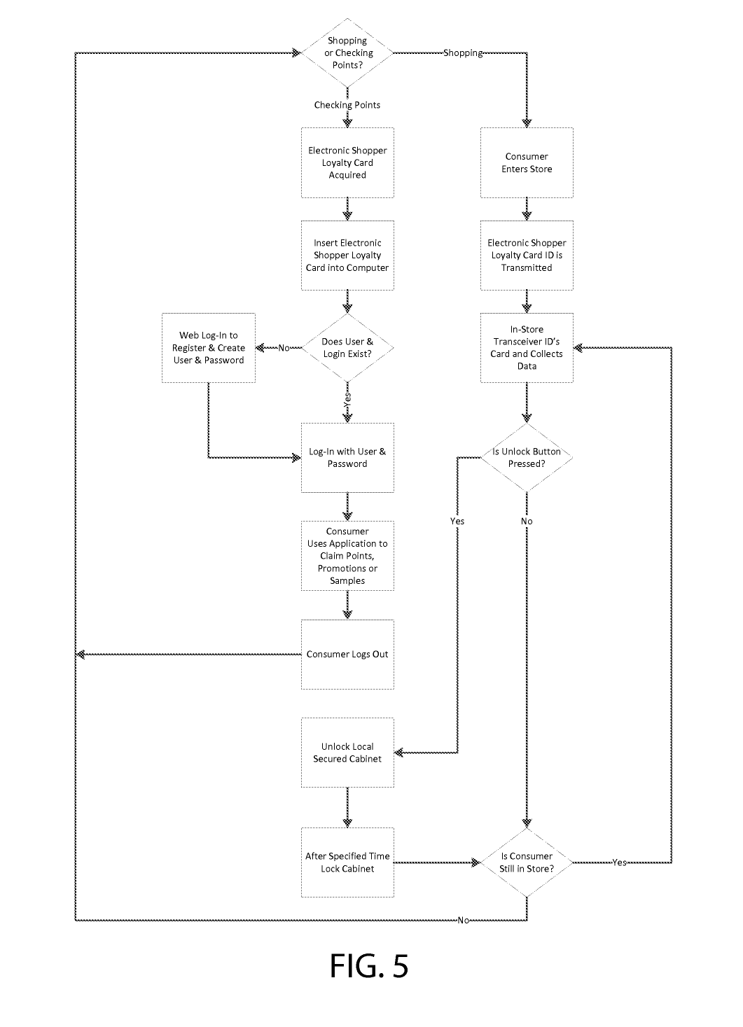

### DETAILED DESCRIPTION

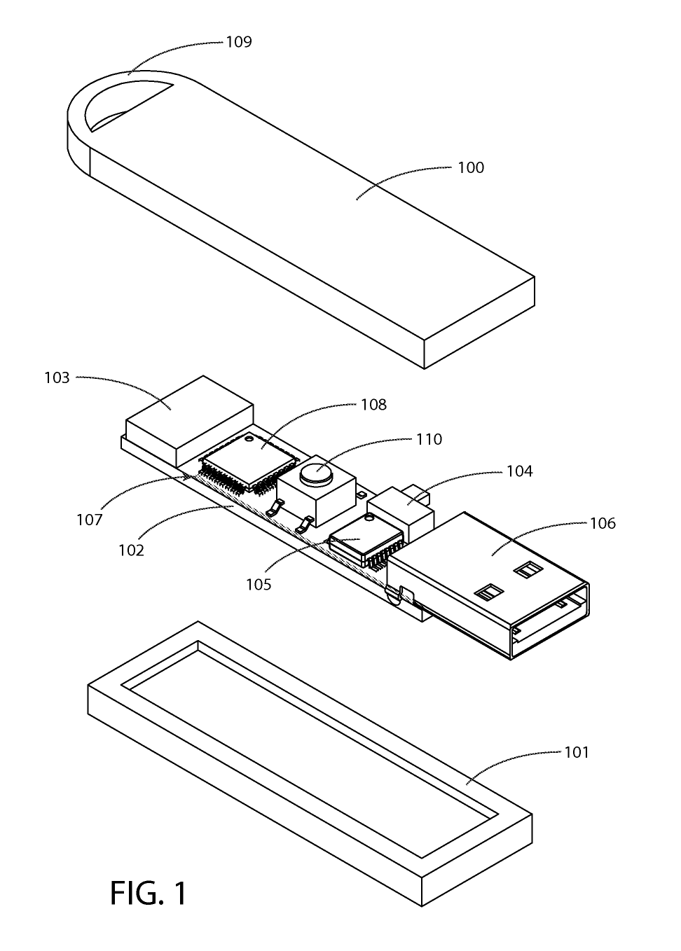

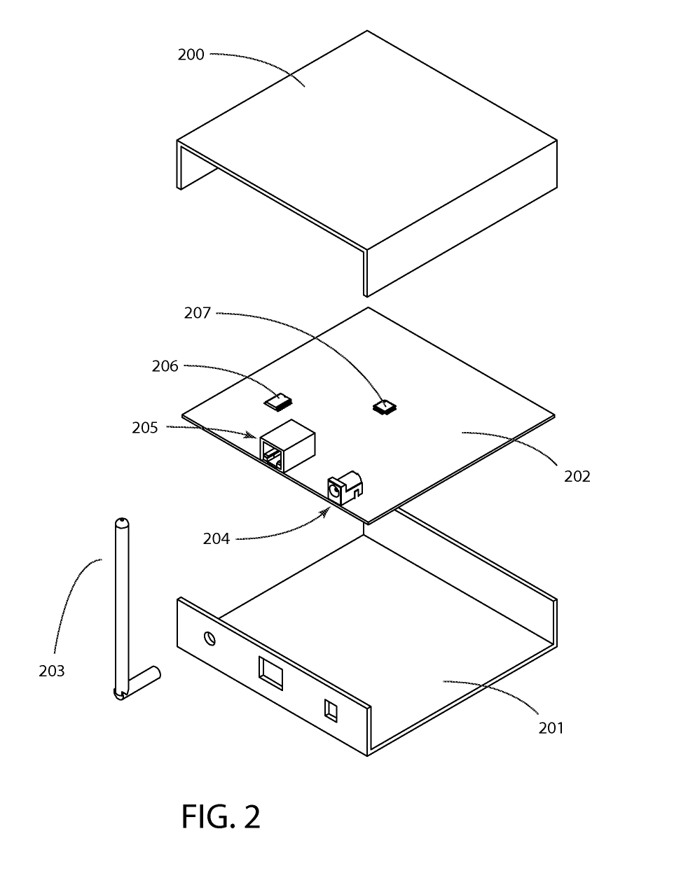

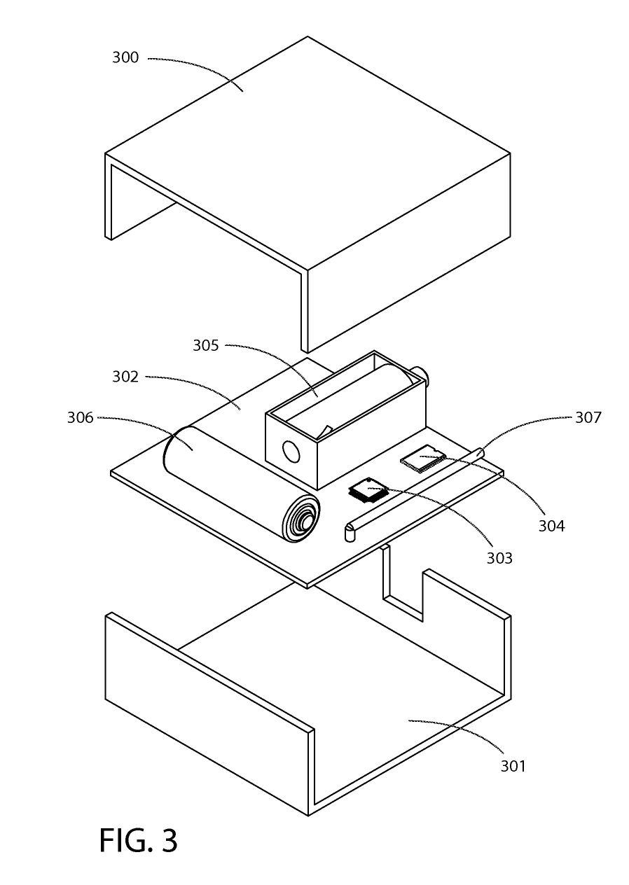

Certain embodiments of the invention comprise of an electronic shopper loyalty card as shown in FIG. 1 for the wireless identification of the consumer and a method for web site entry authentication. The electronic shopper loyalty card's outer construction consists of a top 100 and bottom 101 housing made of high-impact plastic with a metal or plastic key ring attachment 109. The internal electronics consist of a rigid printed circuit board 102 with mechanical and integrated electronics sections. The mechanical section consist of a slide-switch 104 that is used to turn the device on and off and a tact switch 110 that is used to trigger the transceiver 105 to send a door open command to a door receiver and lock mechanism as shown in FIG. 3. The integrated electronics section consists of a microcontroller 108 that is used to operate the USB bus 106 and transceiver 105 as well as managing the batteries 103 charging logic. Additionally, the transceiver is attached to an integrated microstrip or wire antenna 107 which is etched or attached onto the printed circuit board 102. The combination of microstrip antenna 107, microcontroller 108 and transceiver 105 allows the electronic shopper loyalty card to communicate with the instore transceivers as shown in FIG. 2.

Certain embodiments of the invention comprise of an internet connected instore transceiver as shown in FIG. 2. for instore collection of data from the electronic shopper loyalty card as shown in FIG. 1. The instore transceivers outer construction consists of a top 200 and bottom 201 housing made of either metal or injection molded plastic that would be shelf or wall mounted. The internal electronics consist of a rigid printed circuit board 202, power connection 204, RJ-45 connector 205 for connection to the Internet, an antenna 203, microcontroller 207 and transceiver 206. When the electronic shopper loyalty card as shown in FIG. 1 transmits information it is then received by the antenna 203 and processed through the transceiver 206 and microcontroller 207. This information is then sent from the microcontroller 207 to the Internet via the RJ-45 connection 205 on the instore transceiver.

Certain embodiments of the invention comprise of a wireless locking mechanism as shown in FIG. 3 used to receive wireless signals from the electronic shopper loyalty card as shown in FIG. 1. to unlock secured product. This mechanism would be retrofitted in existing or be designed into new secured retail display cabinets. The locking mechanism would consist of a top 300 and bottom 301 ruggedized housing to protect the electro-mechanical assembly. The electro-mechanical assembly would consist of a printed circuit board 302, microprocessor 303, receiver or transceiver 304, solenoid 305, battery 306 and an embedded microstrip or wire antenna 307. In a normal operating scenario the consumer would push the unlock tact switch 110 on the electronic shopper loyalty card which would send an unlock signal from the antenna 107 as pictured in FIG. 1. This signal would be received by the locking mechanisms antenna 307 and activate the solenoid 305 to unlock the door as shown in FIG. 3.

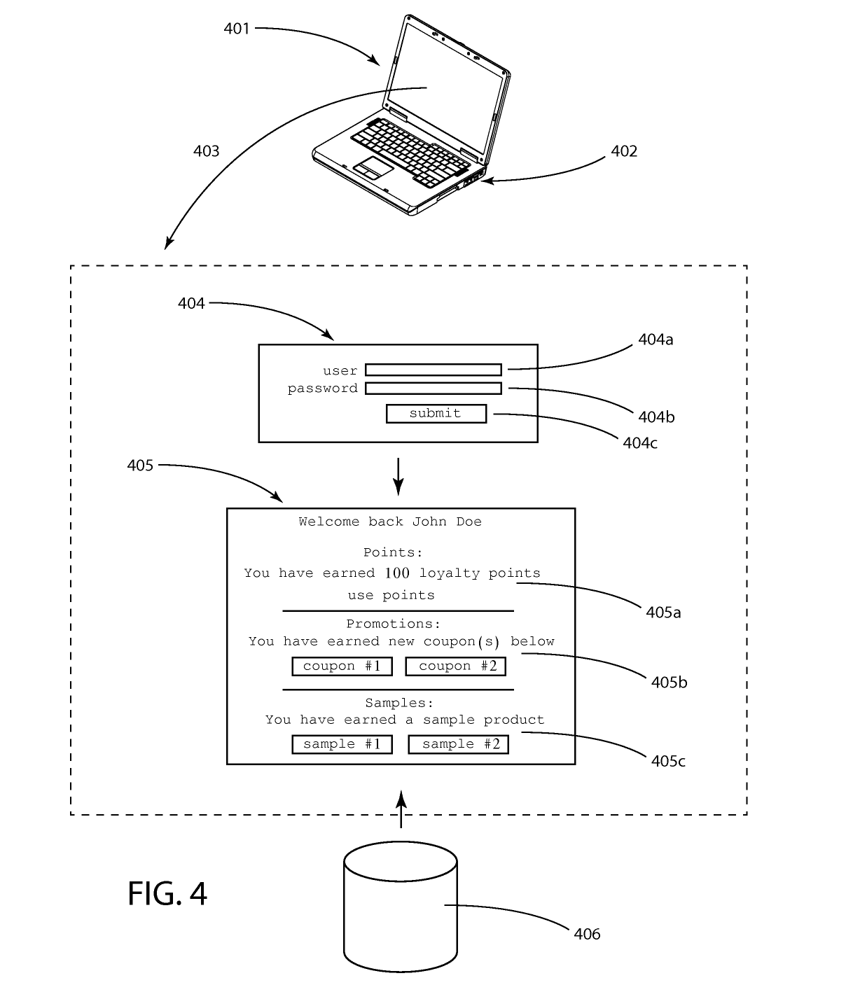

Certain embodiments of the invention comprise of a web page interface as shown in FIG. 4. used to display information to the consumer from data received from the electronic shopper loyalty card and instore transceiver(s) as shown in FIG. 1 and FIG. 2 respectively. The web page GUI or graphical user interface is displayed on a web capable computer or laptop 401 with a standard USB port 402 interface. The consumer would plug the electronic shopper loyalty card as shown in FIG. 1 into the computers USB port 402. The electronic shopper loyalty card then would launch the application 403 which would take the consumer to a login screen 404 and authenticate the card and require a user name 404a, login 404b and acceptance of the terms and agreement by pressing the submit button 404c. Once logged in the consumer would be shown an activity screen 405 that would display; loyalty points 405a, promotions 405b and manufacturer sample offers 405c. All of the dynamic data displayed on the web application 403 would be driven from a centralized database 406. This database 406 would be preprogrammed to calculate the point structure, promotions and manufacturers sample offers in advance. Retailers and product manufacturers could log-on to the application 403 and make changes to these offers though the retail and manufacturers web page section. The amount of information displayed is not limited to the above list but is an example could be presented to the consumer.

While the invention has been described in detail with particular reference to the disclosed embodiments, it will be understood that variations and modifications can be affected within the spirit and scope of the invention as described herein.

What is claimed is:

1. A method of collecting a retail shoppers actions comprising of:
a. a battery powered electronic shopper loyalty card;
b. with the capability of transmitting; and
c. receiving data.

2. A method to send and receive data from the device as stated in Claim lover the Internet to be stored in a centralized database.

3. A method for the consumer to unlock secured retail displays using a button on the device stated in claim 1.

4. A method to display the data collected from the device as stated in claim 2 comprising of:
a. a secured login page using the USB connection of the device as stated in claim 1, user name & password;
b. a main page allowing for the display and utilization of loyalty points, promotions, and manufacturers sample offers by the consumer; and
c. a main administration page to allow the retailer and product manufacturers to set point levels, promotions and offers.
